(19) United States
(12) Patent Application Publication
(10) Pub. No.: US 2025/0379799 A1
(43) Pub. Date: Dec. 11, 2025

(54) FAULT CAUSE IDENTIFICATION SUPPORT DEVICE, FAULT CAUSE IDENTIFICATION SUPPORT METHOD, AND RECORDING MEDIUM

(71) Applicant: NEC Corporation, Tokyo (JP)

(72) Inventor: Masanao NATSUMEDA, Tokyo (JP)

(73) Assignee: NEC Corporation, Tokyo (JP)

(21) Appl. No.: 19/208,678

(22) Filed: May 15, 2025

(30) Foreign Application Priority Data
Jun. 5, 2024 (JP) 2024-091132

(51) Int. Cl. H04L 41/16; H04L 41/0631; H04L 41/069

(52) U.S. Cl. CPC H04L 41/16; H04L 41/065; H04L 41/069

(57) ABSTRACT

In a fault cause identification support device, an error message acquisition means acquires an error message from an IT system. A configuration information acquisition means acquires configuration information of the IT system. A device state acquisition means acquires state information of each of devices forming the IT system based on the error message and the configuration information. A question sentence generation means generates a first question sentence including the error message, the configuration information, the state information, and an instruction sentence for instructing analysis of an error cause. A response means inputs the first question sentence to a large-scale language model and acquire one or more candidates of the error cause as an answer. Thus, the fault cause identification support device capable of supporting in identifying a cause of a fault in the IT system is provided.

### TECHNICAL FIELD

This disclosure relates to a technique for identifying a fault cause.

### BACKGROUND ART

A technology for detecting each system fault and identifying the cause has been known. For example, Patent Literature 1 describes a control program, a control method, and a control device that streamline an analysis of a fault cause in a virtualized system.
Patent Document 1: Japanese Patent 7401764

### SUMMARY

Due to the virtualization and large-scale expansion of an IT system, operational tasks have become complex, making it difficult to identify a fault cause when fault occur. Even with the method of Patent Literature 1, fault causes cannot always be identified flexibly.

One object of the present disclosure is to provide a fault cause identification support device capable of supporting identification of each fault cause in the IT system.

According to an example aspect of the present invention, there is provided a fault cause identification support device, comprising:
at least one memory configured to store instructions; and
at least one processor configured to execute the instructions to:
acquire an error message from an IT system;
acquire configuration information of the IT system;
acquire state information of each of devices forming the IT system based on the error message and the configuration information;
generate a first question sentence including the error message, the configuration information, the state information, and an instruction sentence for instructing analysis of an error cause; and
input the first question sentence to a large-scale language model and acquire one or more candidates of the error cause as an answer.

According to another example aspect of the present invention, there is provided a fault cause identification support method executed by a computer, comprising:
acquiring an error message from an IT system;
acquiring configuration information of the IT system;
acquiring state information of devices constituting the IT system based on the error message and the configuration information;
generating a first question sentence including the error message, the configuration information, the state information, and an instruction sentence for instructing analysis of an error cause; and
inputting the first question sentence to a large-scale language model and acquiring one or more candidates of the error cause as an answer.

According to still another example aspect of the present invention, there is provided a recording medium recording a program, the program causing a computer to execute processing of:
acquiring an error message from an IT system;
acquiring configuration information of the IT system;
acquiring state information of devices constituting the IT system based on the error message and the configuration information;
generating a first question sentence including the error message, the configuration information, the state information, and an instruction sentence for instructing analysis of an error cause; and
inputting the first question sentence to a large-scale language model and acquiring one or more candidates of the error cause as an answer.

### Effect

According to the present disclosure, it is possible to support identification of each fault cause in an IT system.

### BRIEF DESCRIPTION OF THE DRAWINGS

FIG. 1 illustrates an overall configuration of a fault cause identification support system according to the present disclosure.

FIG. 2 is a block diagram illustrating a hardware configuration of the fault cause identification support device according to the present disclosure.

FIG. 3 is a block diagram illustrating a functional configuration of the fault cause identification support device according to the present disclosure.

FIG. 4A and FIG. 4B are diagrams for explaining a process of a configuration information acquisition unit.

FIG. 5A and FIG. 5B illustrate examples of a question sentence.

FIG. 6 illustrates an example of an answer.

FIG. 7 is a flowchart of a fault cause analysis process.

FIG. 8 illustrates an example of a question sentence of a modification 1.

FIG. 9 illustrates an example of a question sentence of a modification 2.

FIG. 10 is a block diagram illustrating a functional configuration of another fault cause identification support device according to the present disclosure.

FIG. 11 is a flowchart of a process by another fault cause identification support device according to the present disclosure.

### EXAMPLE EMBODIMENTS

Preferred example embodiments of the present disclosure will be described with reference to the accompanying drawings.

### First Example Embodiment

### [Overall Configuration]

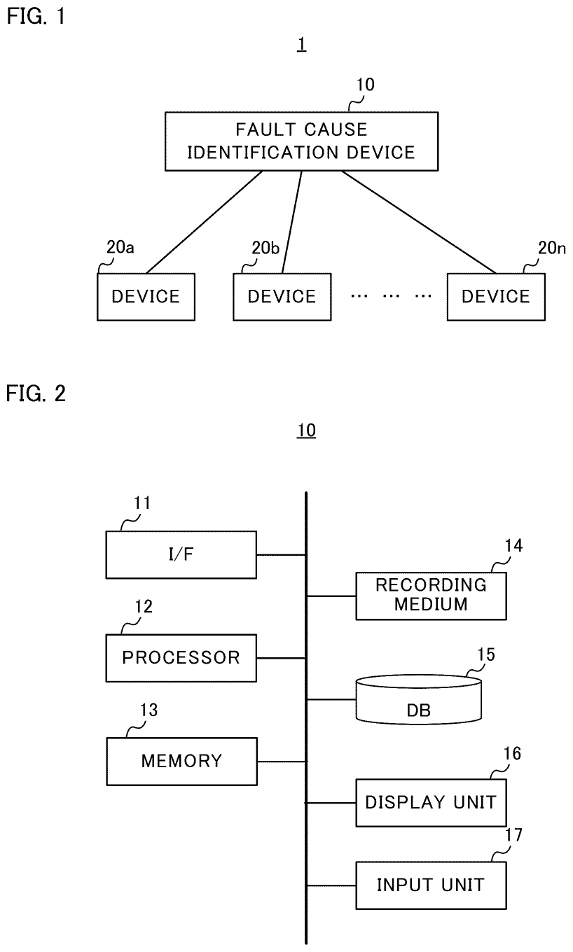

FIG. 1 shows an overall configuration of a fault cause identification support system to which a fault cause identification support device according to the present disclosure is applied. The fault cause identification support system 1 includes a fault cause identification support device 10 and a plurality of devices 20 forming an IT system. Note that for each device 20, a subscript is attached to the device 20 in a case of distinguishing individual devices, and each device 20 is simply referred to as the “device 20” in a case of not distinguishing. The fault cause identification support device 10 and each device 20 can communicate with each other wirelessly or wired.

In a case where a fault occurs in the device 20, the fault cause identification support device 10 presents one or more fault cause candidates. Specifically, the fault cause identification support device 10 generates a question sentence for causing a large-scale language model (LLM: Large Language Models) such as ChatGPT (registered trademark) to analyze a fault cause based on an error message received from the device 20, partial configuration information of the IT system, and a state of the device 20. Then, the fault cause identification support device 10 inputs the question sentence to the LLM, and acquires an answer (fault cause) for the question sentence from the LLM.

As described above, the fault cause identification support device 10 uses the LLM for an analysis of the fault cause. Accordingly, it is possible to eliminate a need for the fault cause identification support device 10 to define rules for identifying the fault cause for each system, and to flexibly analyze the fault cause.

The device 20 is a device forming the IT system, for instance, a container or a virtual machine. The device 20 sends the error message to a fault cause identification support device 10 in a case where an error occurs on the device 20. For instance, a device 20a sends the error message to the fault cause identification support device 10 in a case where an error occurs in the software executed by device 20a.

### [Hardware Configuration]

FIG. 2 is a block diagram illustrating a hardware configuration of the fault cause identification support device 10 according to a first example embodiment. As illustrated, the fault cause identification support device 10 includes an interface (I/F) 11, a processor 12, a memory 13, a recording medium 14, and a database (DB) 15.

The I/F 11 is used to input and output data with an external device. Specifically, the I/F 11 receives the error message and the like from the device 20.

The processor 12 is a computer such as the CPU (Central Processing Unit), and controls the entire fault cause identification support device 10 by executing programs prepared in advance. Note that the processor 12 may be the GPU (Graphics Processing Unit), the DSP (Digital Signal Processor), the MPU (Micro Processing Unit), the FPU (Floating Point number Processing Unit), the PPU (Physics Processing Unit), the TPU (Tensor Processing Unit), a quantum processor, a microcontroller, or a combination of these. The processor 12 executes the fault cause analysis process described later.

The memory 13 is formed by a ROM (Read Only Memory), a RAM (Random Access Memory), and the like. The memory 13 is also used as a working memory during executions of various processes by the processor 12.

The recording medium 14 is a non-volatile and non-transitory recording medium such as a disk-shaped recording medium or a semiconductor memory, and is configured to be detachable from the fault cause identification support device 10. The recording medium 14 records various programs executed by the processor 12. In a case where the fault cause identification support device 10 executes various processes, corresponding programs recorded in the recording medium 14 are loaded into the memory 13 and executed by the processor 12.

The DB 15 stores data used in a case where the fault cause identification support device 10 executes the fault cause analysis process. For instance, the DB 15 stores the configuration information of the IT system and respective states of the devices 20 forming the IT system. Note that instead of the DB 15 storing the states of each device, the processor 12 may receive the state of each device from an external device not illustrated in FIG. 2 via the I/F 11, or receive respective states from the devices 20 forming the IT system.

The display unit 16 is, for instance, a liquid crystal display, and illustrates an analysis result of the fault cause. The input unit 17 is, for instance, a mouse, a keyboard, or the like, and is used for an administrator of the fault cause identification support device 10 to perform a necessary management.

### [Functional Configuration]

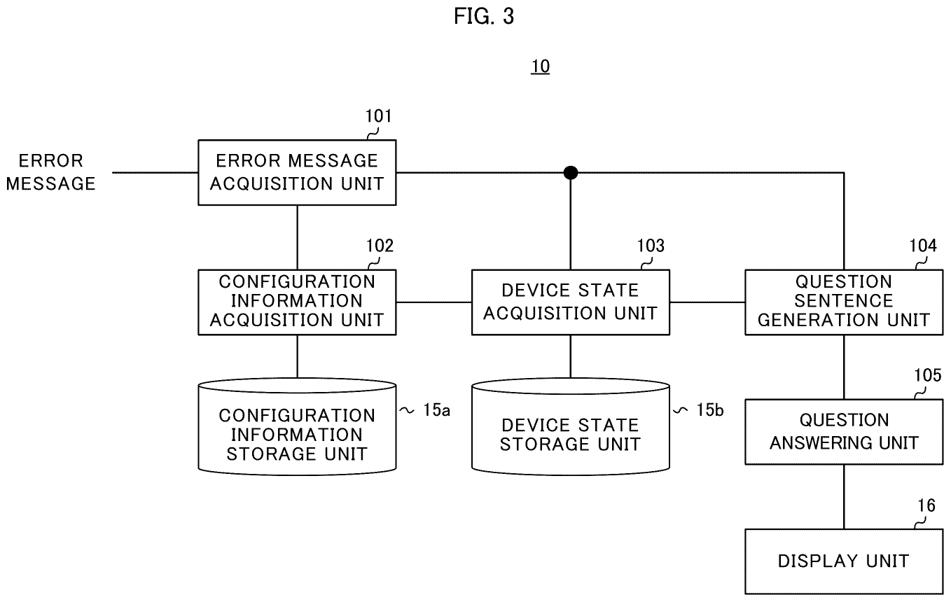

FIG. 3 is a block diagram illustrating a functional configuration of the fault cause identification support device 10 of the first example embodiment. Functionally, the fault cause identification support device 10 includes an error message acquisition unit 101, a configuration information acquisition unit 102, a device state acquisition unit 103, a question sentence generation unit 104, a question answering unit 105, a configuration information storage unit 15a, and a device state storage unit 15b, in addition to the display unit 16 described above.

Note that the configuration information storage unit 15a and the device state storage unit 15b are realized by the DB 15 illustrated in FIG. 2. Also, the error message acquisition unit 101, the configuration information acquisition unit 102, the device state acquisition unit 103, the question sentence generation unit 104, and the question answering unit 105 are formed by the processor 12 illustrated in FIG. 2 which performs corresponding processes.

First, the fault cause identification support device 10 receives the error message from the device 20 through the I/F 11. The error message is input to the error message acquisition unit 101. The error message includes the error occurrence time or the error content and the like. The error message acquisition unit 101 outputs the received error message to the configuration information acquisition unit 102, the device state acquisition unit 103, and the question sentence generation unit 104.

In the configuration information storage unit 15a, the configuration information of the IT system is stored in advance. The configuration information of the IT system indicates various information about the device forming the IT system. Based on the error message, the configuration information acquisition unit 102 extracts the configuration information of the device related to the error (hereinafter, also referred to as the “partial configuration information”) from the configuration information of the IT system.

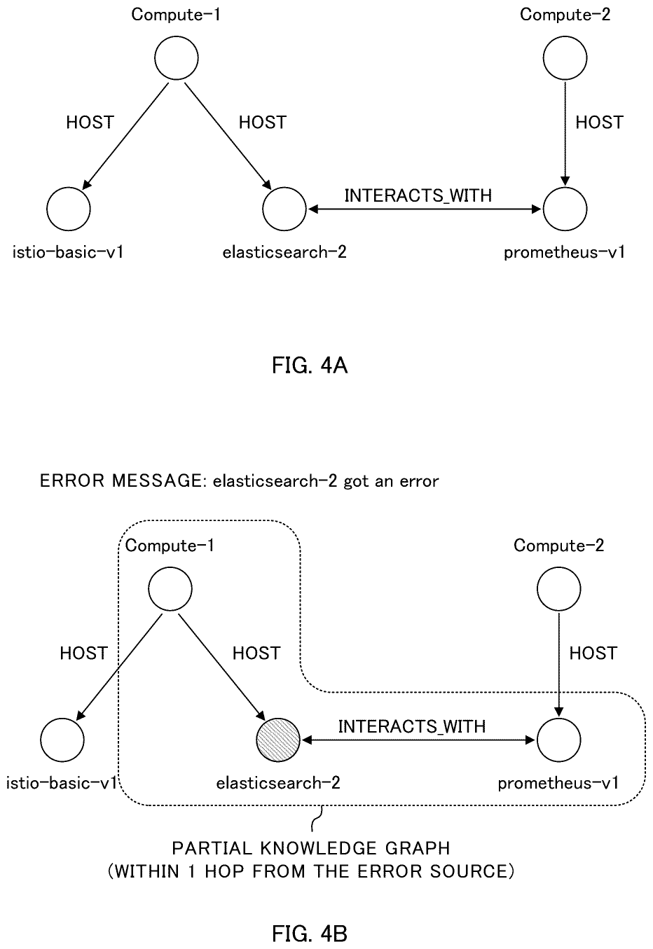

Specifically, the configuration information storage unit 15a in this example embodiment stores the configuration information of the IT system as a knowledge graph. The configuration information acquisition unit 102 extracts the knowledge graph within a predetermined range (hereinafter also referred to as a “partial knowledge graph”) from the entire knowledge graph based on a source of the error. FIG. 4A and FIG. 4B are diagrams for explaining a process of the configuration information acquisition unit 102. FIG. 4A shows an example of the knowledge graph stored in the configuration information storage unit 15a. In the knowledge graph of FIG. 4A, components of the IT system are represented by nodes, and the relationships between the components are represented by edges. For example, in FIG. 4A, a directed edge is added from a “Compute-1” node to an “elasticsearch-2” node, and this relationship indicates “HOST” (that is, on a physical machine called the Compute-1, the elasticsearch-2 container is running). Also, in FIG. 4A, a bidirectional edge is added between an “elasticsearch-2” node and a “prometheus-v1” node, and this relationship indicates “INTERACTS_WITH” (that is, information is being exchanged).

FIG. 4B shows an example of the partial knowledge graph. In FIG. 4B, it is assumed that the fault cause identification support device 10 receives the error message “elasticsearch-2 got an error”. The configuration information acquisition unit 102 acquires the partial knowledge graph including components within a predetermined number of hops from “elasticsearch-2”, which is the source of the error. In FIG. 4B, the configuration information acquisition unit 102 acquires the partial knowledge graph including components within one hop from the source of the error.

The configuration information acquisition unit 102 outputs the partial knowledge graph to the device state acquisition unit 103 as the partial configuration information. Note that the configuration information acquisition unit 102 may output the entire knowledge graph (that is, the configuration information of the IT system) to the device state acquisition unit 103 as it is instead of the partial knowledge graph, but by using the partial knowledge graph, it is possible to analyze the cause of the fault more accurately.

Returning to FIG. 3, the state of each device is stored in advance in the device state storage unit 15b. The state of the device is data indicating the operating status of the device, and includes, for instance, metrics data such as a CPU usage rate, a RAM usage rate, a transfer data amount, a received data amount, and message logs such as syslog. The device state acquisition unit 103 acquires a value of each data item from the device state storage unit 15b based on the error message and the partial configuration information. It is assumed that the device state acquisition section 103 acquires each value of data items determined in advance. The state of the device acquired by the device state acquisition unit 103 (that is, the predetermined value of each data item) is hereinafter also referred to as “state information”.

Specifically, the device state acquisition unit 103 acquires the state information of the device related to the error based on the partial configuration information. For the metrics data, the device state acquisition unit 103 may acquire it as a predetermined statistical value such as an average value, a minimum value, or a maximum value for a predetermined period. Also, for the message log, the device state acquisition unit 103 may use a plurality of predefined log templates to total the number of message logs that match each template.

Furthermore, the device state acquisition unit 103 acquires state information at a predetermined time point based on the error occurrence time. For instance, the device state acquisition unit 103 may acquire the state information at a past time closest to a time the error occurred, or may acquire the state information at a time that is a predetermined period of time back from the time the error occurred.

The device state acquisition unit 103 outputs the partial configuration information input from the configuration information acquisition unit 102 and the state information, to the question sentence generation unit 104.

Instead of acquiring the state information from the device state storage unit 15b, the device state acquisition unit 103 may acquire the state information by querying an external data lake where the state of the device is stored. Alternatively, each device may store its own state information and transmit the state information to the device state acquisition unit 103 in response to a request from the device state acquisition unit 103.

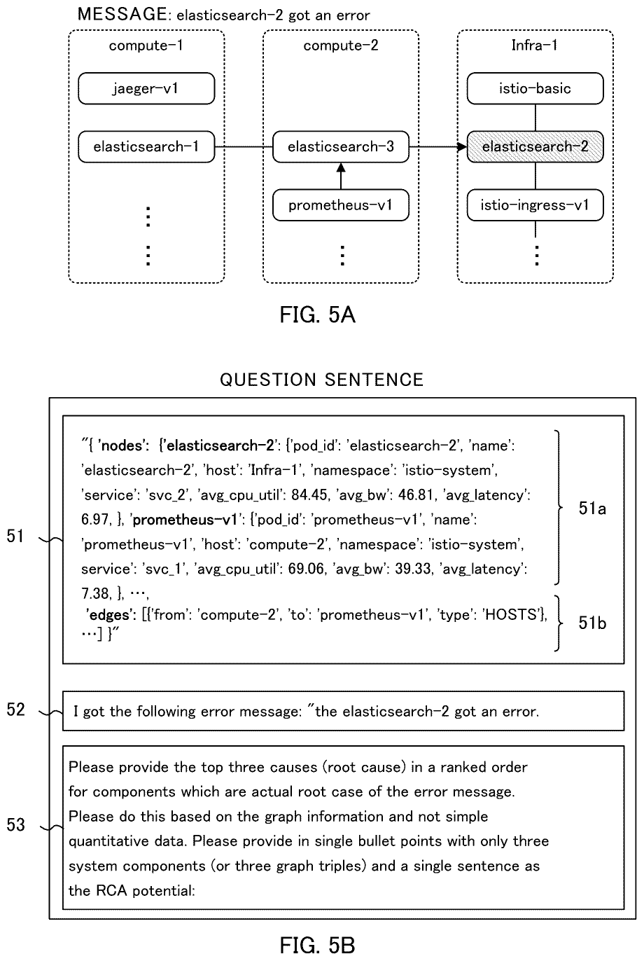

The question sentence generation unit 104 generates a question sentence to be input to the LLM based on the error message, the partial configuration information, and the state information. FIG. 5A and FIG. 5B are examples of the question sentence. The question sentence generation unit 104 generates a question sentence as illustrated in FIG. 5B from the configuration of the IT system and the error message illustrated in FIG. 5A. The configuration of the IT system in FIG. 5A includes three physical machines: compute-1, compute-2, and Infra-1, and a plurality of containers are running on each physical machine.

The question sentence of FIG. 5B includes an input area 51 for the partial configuration information and the state information, an input area 52 for the error message, and an input area 53 for an instruction sentence.

In the input area 51, the partial knowledge graph described in a JSON format is input. The input area 51 includes node information 51a regarding the nodes of the partial knowledge graph and edge information 51b regarding the edges of the partial knowledge graph. In the node information 51a of FIG. 5B, for instance, the information regarding an “elasticsearch-2” node and information regarding a “prometheus-v1” node are illustrated. Note that the state information is included in the node information 51a. For instance, the “elasticsearch-2” node includes the state information such as an average CPU usage rate (avg_cpu_util), an average transfer data amount (avg_bw), and an average latency (avg_latency). Also, in the edge information 51b of FIG. 5B, for instance, a relationship between a “compute-2” node and a “prometheus-v1” node is illustrated.

In the input area 52, the error message received from the device 20 is input. In the input area 53 of the instruction sentence, the instruction sentence prepared in advance is input. In the input area 53 of the instruction sentence in FIG. 5B, the instruction sentence describing, for instance, to present the top three components that are a root cause of the error and to describe the reason in one sentence, is input.

Returning to FIG. 3, the question sentence generation unit 104 outputs the generated question sentence to the question answering unit 105.

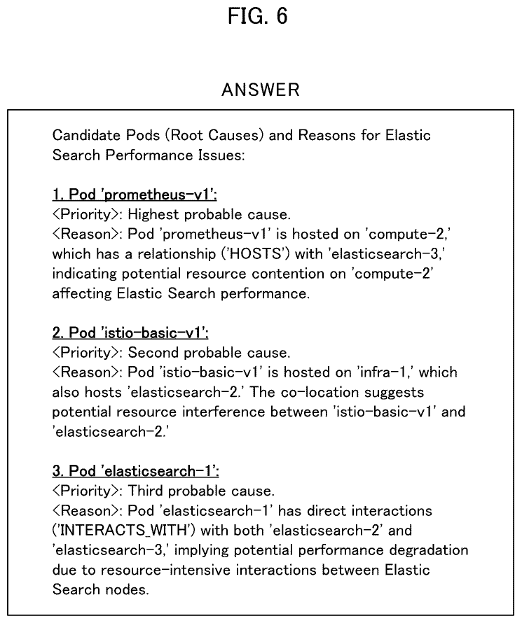

The question answering unit 105 inputs the question sentence to the LLM and acquires an answer from the LLM. FIG. 6 illustrates an example of the answer from the LLM. Note that the answer in FIG. 6 is assumed to be the answer from the LLM to the question sentence of FIG. 5B. In FIG. 6, “prometheus-v1”, “istio-basic-v1”, and “elasticsearch-1” are presented with reasons as the components that are likely to be root causes of the error. Note that in FIG. 6, “prometheus-v1” is listed as the component with the highest possibility of being the root cause of the error, and as the reason, it is described that “prometheus-v1” and “elasticsearch-3” are hosted on the same “compute-2”, and the resource contention occurs between “prometheus-v1” and “elasticsearch-3” and may have affected “elasticsearch-2” which is interacting with “elasticsearch-3”.

Returning to FIG. 3, the question answering unit 105 outputs the answer to the display unit 16. The display unit 16 displays the answer on the display. The user can infer the cause of the fault by looking at the display.

In the above example embodiment configuration, the error message acquisition unit 101 is an example of an error message acquisition means, the configuration information acquisition unit 102 is an example of a configuration information acquisition means, the device state acquisition unit 103 is an example of a device state acquisition means, the question sentence generation unit 104 is an example of a question sentence generation means, and the question answering unit 105 is an example of a response means.

### [Fault Cause Analysis Process]

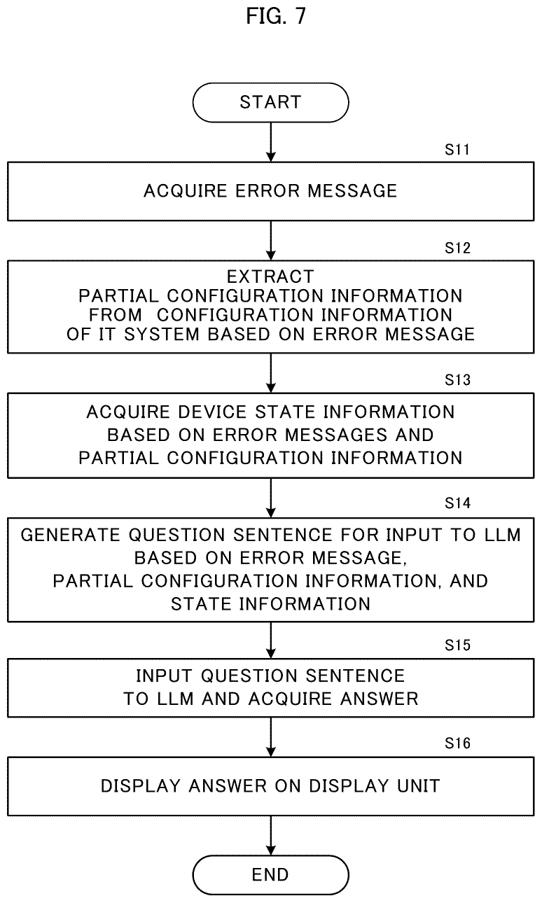

Next, the fault cause analysis process will be described. FIG. 7 is a flowchart of the fault cause analysis process by the fault cause identification support device 10. This fault cause analysis process is realized by the processor 12 illustrated in FIG. 2, which executes a corresponding program prepared in advance and operates as each element illustrated in FIG. 3.

First, the error message acquisition unit 101 acquires an error message from the device 20 (step S11). The error message acquisition unit 101 outputs the acquired error message to the configuration information acquisition unit 102, the device state acquisition unit 103, and the question sentence generation unit 104.

Next, the configuration information acquisition unit 102 extracts the partial configuration information from the configuration information of the IT system based on the error message (step S12). The configuration information acquisition unit 102 outputs the partial configuration information to the device state acquisition unit 103.

Next, the device state acquisition unit 103 acquires the state information of the device from the device state storage unit 15b based on the error message and the partial configuration information (step S13). The device state acquisition unit 103 outputs the partial configuration information and the state information to the question sentence generation unit 104.

Next, the question sentence generation unit 104 generates the question sentence to be input to the LLM based on the error message, the partial configuration information, and the state information (step S13). The question sentence includes the partial configuration information and the state information, the error message, and the instruction sentence. The question sentence generation unit 104 outputs the generated question sentence to the question answering unit 105. Next, the question answering unit 105 inputs the question sentence to the LLM and acquires the answer from the LLM (step S14). The question answering unit 105 outputs the answer to the display unit 16. The display unit 16 displays the answer on the display (step S15). After that, the fault cause analysis process is terminated.

### [Modifications]

Next, modifications of the first example embodiment will be described. The following modifications can be combined as appropriate and applied to the first embodiment.

### (Modification 1)

The configuration information acquisition unit 102 may select the configuration information effective for identifying the cause of the error from the partial configuration information, and output the selected information to the device state acquisition unit 103.

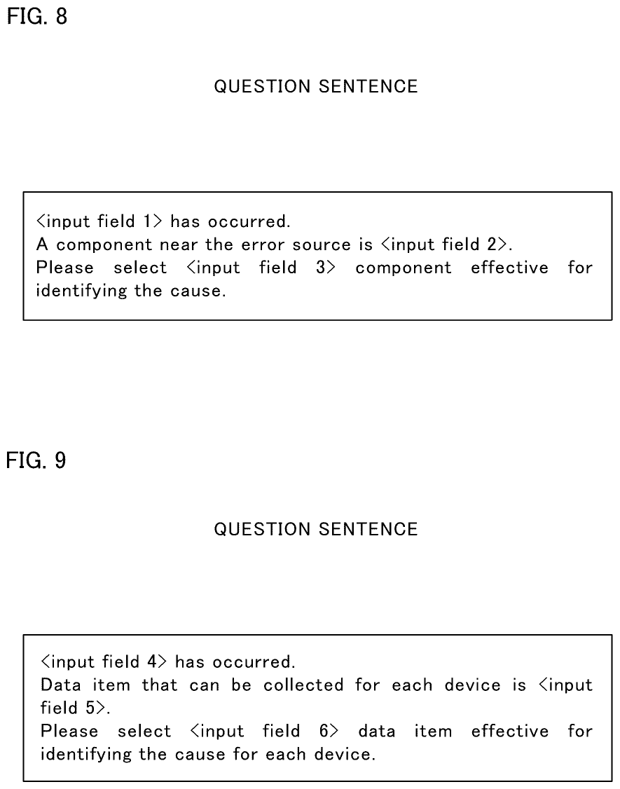

For instance, the configuration information acquisition unit 102 can select the configuration information effective for identifying the cause of the error by using the LLM. Specifically, the configuration information acquisition unit 102 generates the question sentence to be input to the LLM based on the error message and the partial configuration information extracted from the configuration information storage unit 15a. FIG. 8 illustrates an example of the question sentence. The configuration information acquisition unit 102 inputs the error message, the partial configuration information, and the number of the components (nodes) to be output to input fields 1 to 3, respectively, and generates the question sentence. The configuration information acquisition unit 102 inputs the generated question sentence to the LLM, and acquires the configuration information effective for identifying the cause of the error as an answer from the LLM. Then, the configuration information acquisition unit 102 outputs the configuration information effective for identifying the cause of the error to the device state acquisition unit 103. Note that the configuration information acquisition unit 102 can also generate the question sentence by using the configuration information of the IT system, instead of the partial configuration information.

As described above, by using the configuration information effective for identifying the cause of the error in a subsequent process, it is possible to analyze the fault cause more accurately.

### (Modification 2)

In the first example embodiment, the device state acquisition unit 103 acquires the value of the data item determined in advance. Instead, it is possible for the device state acquisition unit 103 to select the data item effective for identifying the cause of the error, and acquire the value of that data item.

For instance, the device state acquisition unit 103 can select one or more data items effective for identifying the cause of the error by using the LLM. Specifically, the device state acquisition unit 103 generates the question sentence to be input to the LLM based on the error message and the partial configuration information. FIG. 9 illustrates an example of the question sentence. The device state acquisition unit 103 inputs the error message, the list of the data items that can be acquired from the device state storage unit 15b, and the number of the data items to be output to input fields 4 to 6, respectively, and generates the question sentence. The device state acquisition unit 103 inputs the generated question sentence to the LLM, and acquires one or more data items effective for identifying the cause of the error as an answer from the LLM. Then, the device state acquisition unit 103 acquires respective values of the one or more data items effective for identifying the cause of the error from the device state storage unit 15b, and outputs the value to the question sentence generation unit 104.

As described above, by using the value of the data item effective for identifying the cause of the error in the subsequent process, it is possible to analyze the fault cause more accurately.

### Second Example Embodiment

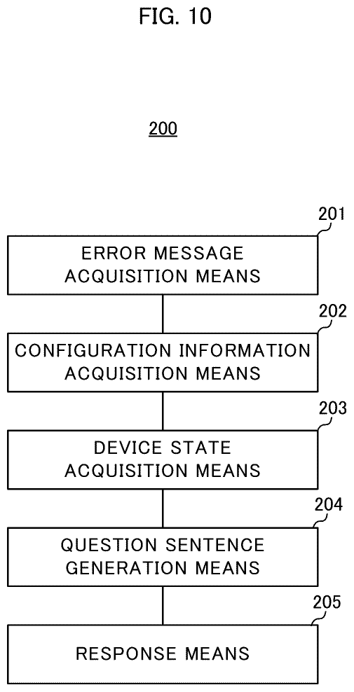

FIG. 10 is a block diagram illustrating a functional configuration of the fault cause identification support device of a second example embodiment. A fault cause identification support device 200 includes an error message acquisition means 201, a configuration information acquisition means 202, a device state acquisition means 203, a question sentence generation means 204, and a response means 205.

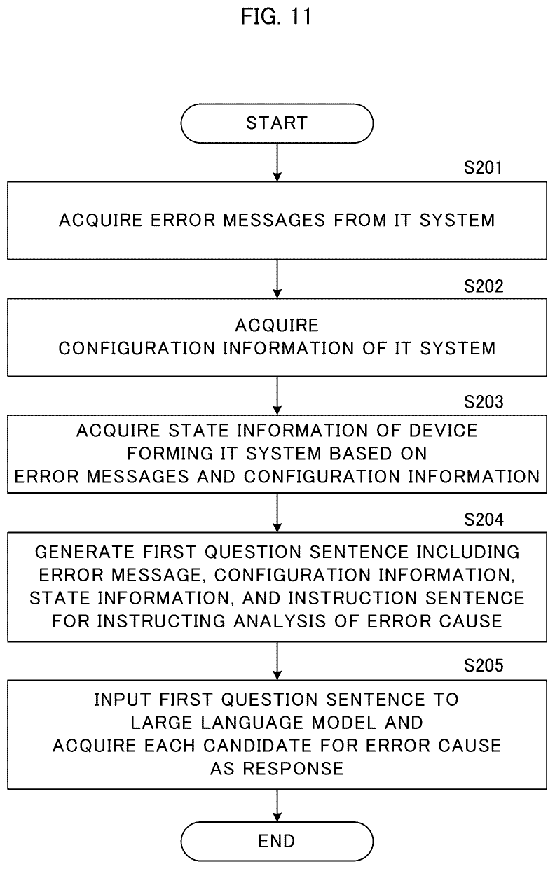

FIG. 11 is a flowchart of a process by the fault cause identification support device of the second example embodiment. The error message acquisition means 201 acquires the error message from the IT system (step S201). The configuration information acquisition means 202 acquires the configuration information of the IT system (step S202). The device state acquisition means 203 acquires the state information of the device forming the IT system based on the error message and the configuration information (step S203). The question sentence generation means 204 generates a first question sentence including the error message, the configuration information, the state information, and the instruction sentence for instructing the analysis of an error cause (step S204). The response means 205 inputs the first question sentence to a large-scale language model and acquires one or more candidates of the error cause as an answer (step S205).

According to the fault cause identification support device 200 of the second example embodiment, it is possible to support identification of a fault cause of the IT system.

A part or all of the example embodiments described above may also be described as the following supplementary notes, but not limited thereto.

### (Supplementary Note 1)

A fault cause identification support device, comprising:
an error message acquisition means configured to acquire an error message from an IT system;
a configuration information acquisition means configured to acquire configuration information of the IT system;
a device state acquisition means configured to acquire state information of each of devices forming the IT system based on the error message and the configuration information;
a question sentence generation means configured to generate a first question sentence including the error message, the configuration information, the state information, and an instruction sentence for instructing analysis of an error cause; and
a response means configured to input the first question sentence to a large-scale language model and acquire one or more candidates of the error cause as an answer.

### (Supplementary Note 2)

The fault cause identification support device according to supplementary note 1, further comprising:
a configuration information storage means configured to store the configuration information of the IT system,
wherein the configuration information acquisition means acquires the configuration information from the configuration information storage means.

### (Supplementary Note 3)

The fault cause identification support device according to supplementary note 2, wherein the configuration information storage means stores the configuration information of the IT system as a knowledge graph.

### (Supplementary Note 4)

The fault cause identification support device according to supplementary note 3, wherein the configuration information acquisition means acquires, as the configuration information, a partial knowledge graph obtained by extracting a predetermined range of the knowledge graph based on the error message.

### (Supplementary Note 5)

The fault cause identification support device according to supplementary note 4, wherein
the knowledge graph includes nodes representing components of the IT system and edges representing relationships between the components,
the configuration information acquisition means acquires, from the knowledge graph, a partial knowledge graph including a component being a source of the error and one or more other components related to the component being the source of the error, and
the one or more other components are within a predetermined number of hops from the component that is the source of the error.

### (Supplementary Note 6)

The fault cause identification support device according to any one of supplementary notes 1 to 5, wherein the configuration information acquisition means inputs a second question sentence including the error message, the configuration information of the IT system, and the instruction sentence for instructing output of configuration information effective for identifying the error cause, to the large-scale language model, and acquires the configuration information as the answer.

### (Supplementary Note 7)

The fault cause identification support device according to any one of supplementary notes 1 to 6, wherein the device state acquisition means inputs a third question sentence including the error message, the configuration information, and an instruction sentence for instructing output of data items effective for identifying the error cause, to a large-scale language model, and acquires the state information based on the data items acquired as an answer.

### (Supplementary Note 8)

The fault cause identification support device according to any one of supplementary notes 1 to 7, further comprising a display means configured to display the one or more candidates of the error cause.

### (Supplementary Note 9)

A fault cause identification support method executed by a computer, comprising:
acquiring an error message from an IT system;
acquiring configuration information of the IT system;
acquiring state information of devices constituting the IT system based on the error message and the configuration information;
generating a first question sentence including the error message, the configuration information, the state information, and an instruction sentence for instructing analysis of an error cause; and
inputting the first question sentence to a large-scale language model and acquiring one or more candidates of the error cause as an answer.

### (Supplementary Note 10)

A program causing a computer to execute processing of:
acquiring an error message from an IT system;
acquiring configuration information of the IT system;
acquiring state information of devices constituting the IT system based on the error message and the configuration information;
generating a first question sentence including the error message, the configuration information, the state information, and an instruction sentence for instructing analysis of an error cause; and
inputting the first question sentence to a large-scale language model and acquiring one or more candidates of the error cause as an answer.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2024-091132, filed on Jun. 5, 2024, the disclosure of which is incorporated herein in its entirety by reference.

### DESCRIPTION OF SYMBOLS

1 Fault Cause Identification Support System
10 Fault Cause Identification Support Device
15 Database (DB)
15a Configuration Information Storage Unit
15b Device State Storage Unit
16 Display Unit
20 Device
101 Error Message Acquisition Unit
102 Configuration Information Acquisition Unit
103 Device State Acquisition Unit
104 Question Sentence Generation Unit
105 Question Answering Unit

1. A fault cause identification support device, comprising:
at least one memory configured to store instructions; and
at least one processor configured to execute the instructions to:
acquire an error message from an IT system;
acquire configuration information of the IT system;
acquire state information of each of devices forming the IT system based on the error message and the configuration information;
generate a first question sentence including the error message, the configuration information, the state information, and an instruction sentence for instructing analysis of an error cause; and
input the first question sentence to a large-scale language model and acquire one or more candidates of the error cause as an answer.

2. The fault cause identification support device according to claim 1, comprising a storage unit configured to store the configuration information of the IT system, wherein
the at least one processor acquires the configuration information from the storage unit.

3. The fault cause identification support device according to claim 2, wherein the at least one processor stores the configuration information of the IT system as a knowledge graph.

4. The fault cause identification support device according to claim 3, wherein the at least one processor acquires, as the configuration information, a partial knowledge graph obtained by extracting a predetermined range of the knowledge graph based on the error message.

5. The fault cause identification support device according to claim 4, wherein
the knowledge graph includes nodes representing components of the IT system and edges representing relationships between the components,
the at least one processor acquires, from the knowledge graph, a partial knowledge graph including a component being a source of the error and one or more other components related to the component being the source of the error, and
the one or more other components are within a predetermined number of hops from the component that is the source of the error.

6. The fault cause identification support device according to claim 1, wherein the at least one processor inputs a second question sentence including the error message, the configuration information of the IT system, and the instruction sentence for instructing output of configuration information effective for identifying the error cause, to the large-scale language model, and acquires the configuration information as the answer.

7. The fault cause identification support device according to claim 1, wherein the at least one processor inputs a third question sentence including the error message, the configuration information, and an instruction sentence for instructing output of data items effective for identifying the error cause, to a large-scale language model, and acquires the state information based on the data items acquired as an answer.

8. The fault cause identification support device according to claim 1, wherein the at least one processor to display the one or more candidates of the error cause on a display unit.

9. A fault cause identification support method executed by a computer, comprising:
acquiring an error message from an IT system;
acquiring configuration information of the IT system;
acquiring state information of devices constituting the IT system based on the error message and the configuration information;
generating a first question sentence including the error message, the configuration information, the state information, and an instruction sentence for instructing analysis of an error cause; and
inputting the first question sentence to a large-scale language model and acquiring one or more candidates of the error cause as an answer.

10. A non-transitory computer-readable recording medium storing a program causing a computer to execute processing of:
acquiring an error message from an IT system;
acquiring configuration information of the IT system;
acquiring state information of devices constituting the IT system based on the error message and the configuration information;
generating a first question sentence including the error message, the configuration information, the state information, and an instruction sentence for instructing analysis of an error cause; and
inputting the first question sentence to a large-scale language model and acquiring one or more candidates of the error cause as an answer.
